(19) United States
(12) Patent Application Publication
(10) Pub. No.: US 2009/0044442 A1
(43) Pub. Date: Feb. 19, 2009

(54) Adjustable Fishing Tackle Box System

(76) Inventor: Mark T. Ryckman, Bismarck, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 11/839,087

(22) Filed: Aug. 15, 2007

(51) Int. Cl. A01K 97/06

(52) U.S. Cl. 43/54.1; 43/57.1

(57) ABSTRACT

An adjustable fishing tackle box system for efficiently securing various fishing lures. The adjustable fishing tackle box system generally includes a container including a base, a pair of sidewalls, a pair of end walls adjacent the pair of sidewalls and a lid, wherein the container includes at least one compartment positioned between the pair of sidewalls. At least one panel is removably positioned within the container, wherein the panel includes a plurality of slots extending within the panel.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to fishing tackle boxes and more specifically it relates to an adjustable fishing tackle box system for efficiently securing various fishing lures.

2. Description of the Related Art

Any discussion of the prior art throughout the specification should in no way be considered as an admission that such prior art is widely known or forms part of common general knowledge in the field.

Fishing tackle boxes have been in use for years. Typically, fishing tackle boxes are utilized by fisherman to hold the currently non-utilized fishing lures while fishing and during storage. Fishing tackle boxes are manufactured in various sizes and are generally adapted to hold various types of fishing lures. A common method utilized to secure lures within various prior fishing tackle boxes is to utilize various small trays or compartments, wherein the lure(s) is positioned within a respective tray.

Positioning lures within the trays can lead to various problems, such as but not limited to multiple lures becoming tangled within the tray thus increasing the time it takes to efficiently remove the untangled lure from the fishing tackle box. Another common problem associated with prior fishing tackle boxes is the tips of lures becoming dull by engaging other lures or elements within the tray.

In addition, another disadvantage with prior fishing tackle boxes is that the boxes are generally manufactured to secure a certain amount of lures, thus forcing the fisherman to at times utilize a larger than necessary fishing tackle box or a fishing tackle box that is too small. Because of the general lack of efficiency and practicality in the prior art there is the need for a new and improved adjustable fishing tackle box system for efficiently securing various fishing lures.

### BRIEF SUMMARY OF THE INVENTION

The general purpose of the present invention is to provide an adjustable fishing tackle box system that has many of the advantages of the fishing tackle boxes mentioned heretofore. The invention generally relates to a fishing tackle box which includes a container including a base, a pair of sidewalls, a pair of end walls adjacent the pair of sidewalls and a lid, wherein the container includes at least one compartment positioned between the pair of sidewalls. At least one panel is removably positioned within the container, wherein the panel includes a plurality of slots extending within the panel.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an adjustable fishing tackle box system for efficiently securing various fishing lures.

Another object is to provide an adjustable fishing tackle box system that may be adapted to efficiently secure various numbers of lures.

An additional object is to provide an adjustable fishing tackle box system that prevents the tips of the lures from becoming dull.

A further object is to provide an adjustable fishing tackle box system that includes panels which are easily inserted or removed from within the container.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention with the lid opened.

FIG. 2 is an upper perspective view of the present invention with the lid opened and the panel exploded outwards.

FIG. 3 is a top view of the present invention illustrating a plurality of fishing lures secured to the panel.

FIG. 4 is a front cross-sectional view of the present invention illustrating a plurality of fishing lures secured to the panel.

FIG. 5 is a side cross-sectional view of the present invention.

FIG. 6 is a side cross-sectional view of the present invention utilizing a plurality of small sized panels to accommodate smaller size fishing lures.

### DETAILED DESCRIPTION OF THE INVENTION

### A. Overview

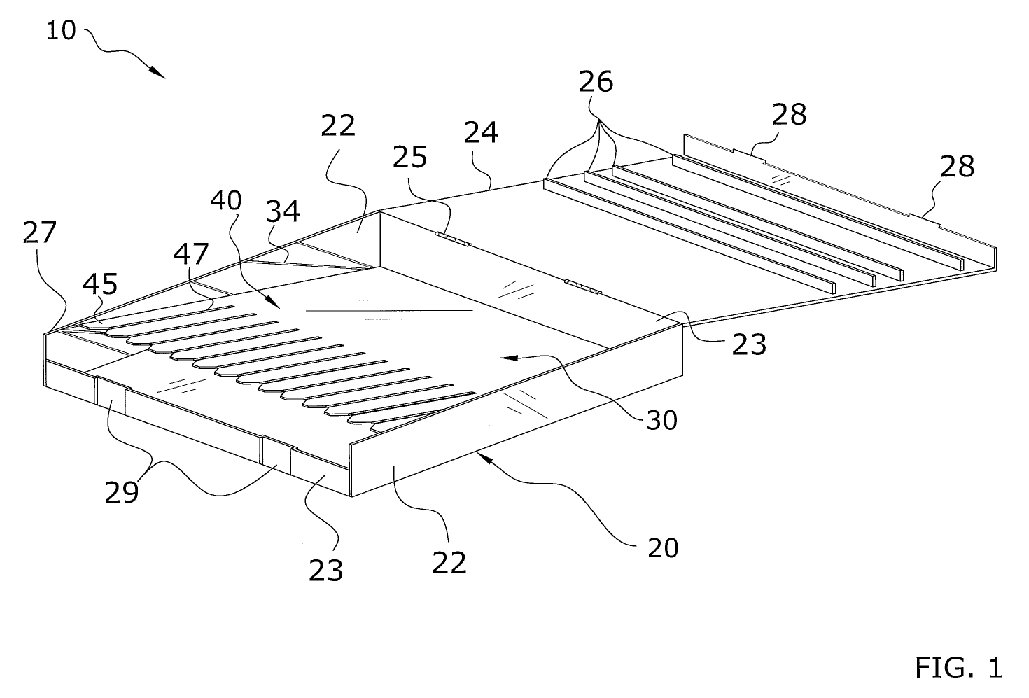

Turning now descriptively to the drawings, in which similar reference characters denote similar elements throughout the several views, FIGS. 1 through 6 illustrate an adjustable fishing tackle box system 10, which comprises a container 20 including a base 21, a pair of sidewalls 22, a pair of end walls 23 adjacent the pair of sidewalls 22 and a lid 24, wherein the container 20 includes at least one compartment 30 positioned between the pair of sidewalls 22. At least one panel 40 is removably positioned within the container 20, wherein the panel 40 includes a plurality of slots 47 extending within the panel 40.

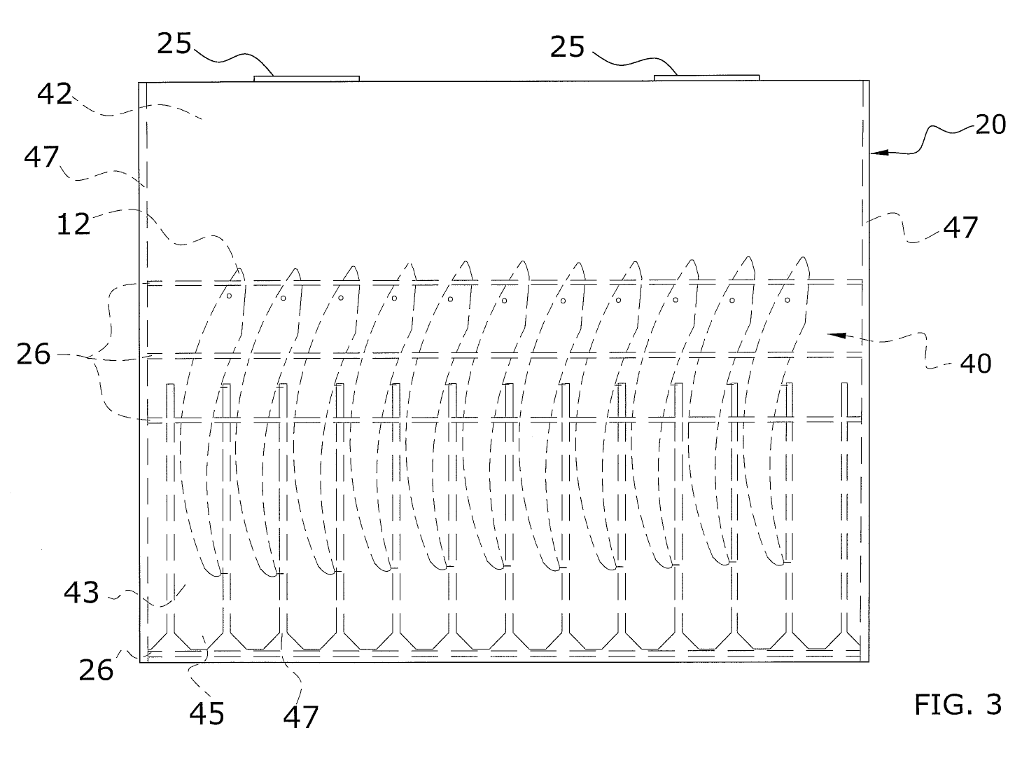

The slots 47 of the panel 40 each removably receive a fishing lure 12, wherein the connecting apparatus between the hook 14 and the body of the fishing lure 12 is slid within a respective slot 47 as illustrated in FIGS. 3, 4 and 6. The present invention may be utilized to secure various types of fishing lures 12, such as but not limited to wobblers, surface lures, spoon lures, plugs, fly lures, Texas Rigs, Mormyshka, Trout worms, Bass worms, Spinnerbait, Crankbaits, Swimbaits, Jerkbaits, Carolina Rigs and various others.

### B. Container

The container 20 is preferably comprised of a compact configuration, wherein multiple containers 20 may be simultaneously carried within a carrying case. The multiple containers 20 may be utilized to hold a numerous amount of a particular type of fishing lure 12, each container 20 hold a different type of fishing lure 12 or various other configurations.

The container 20 is also preferably comprised of a durable and waterproof material, such as but not limited to plastic, wood or metal. The container 20 is further preferably comprised of a rigid structure so as to not bend upon the enclosed fishing lures 12. In the preferred embodiment, the container 20 is comprised of a rectangular shaped structure; however it is appreciated that the container 20 may be comprised of various shapes and configurations rather than the preferred embodiment.

The container 20 includes a base 21, a pair of sidewalls 22 extending upward from the base 21 and upon opposing sides of the base 21. The container 20 also includes a pair of end walls 23 extending upward from opposing ends of the base 21 and between the sidewalls 22 as illustrated in FIGS. 1 through 3. The container 20 also includes a lid 24 to selectively seal an opening 27 extending within the container 20 between the sidewalls 22 and end walls 23.

The lid 24 is preferably pivotally attached to the container 20 via a plurality of hinges 25. In the preferred embodiment the lid 24 is pivotally attached to the end wall 23. It is appreciated however that the lid 24 may selectively cover and uncover the opening 27 in various manners rather than the preferred embodiment, such as but not limited to slidably attaching upon the container 20 and over the opening 27 or removably attaching upon the container 20 and over the opening 27.

The lid 24 also includes at least one first connecting portion 28 (opposite the hinge 25) to secure the lid 24 over the opening 27. The first connecting portion 28 secures to a second connecting portion 29 of the end wall 23 (opposite the hinge 25). The first connecting portion 28 and the second connecting portion 29 may be comprised of various latching mechanisms common in the art of carrying cases, fishing tackle boxes and various other containers all which effectively secure the lid 24 over the opening 27.

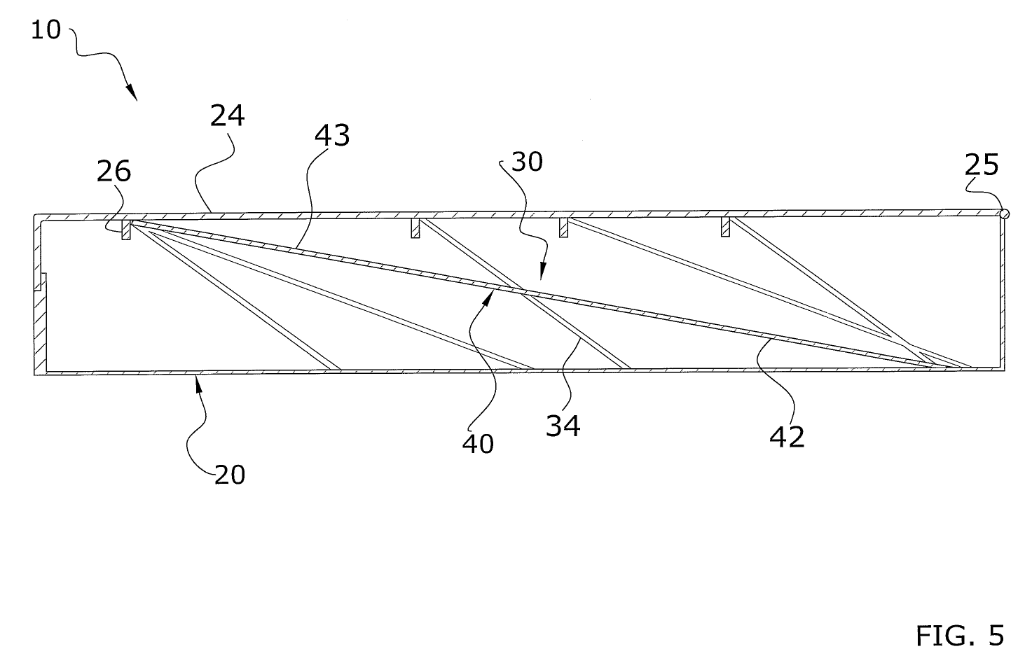

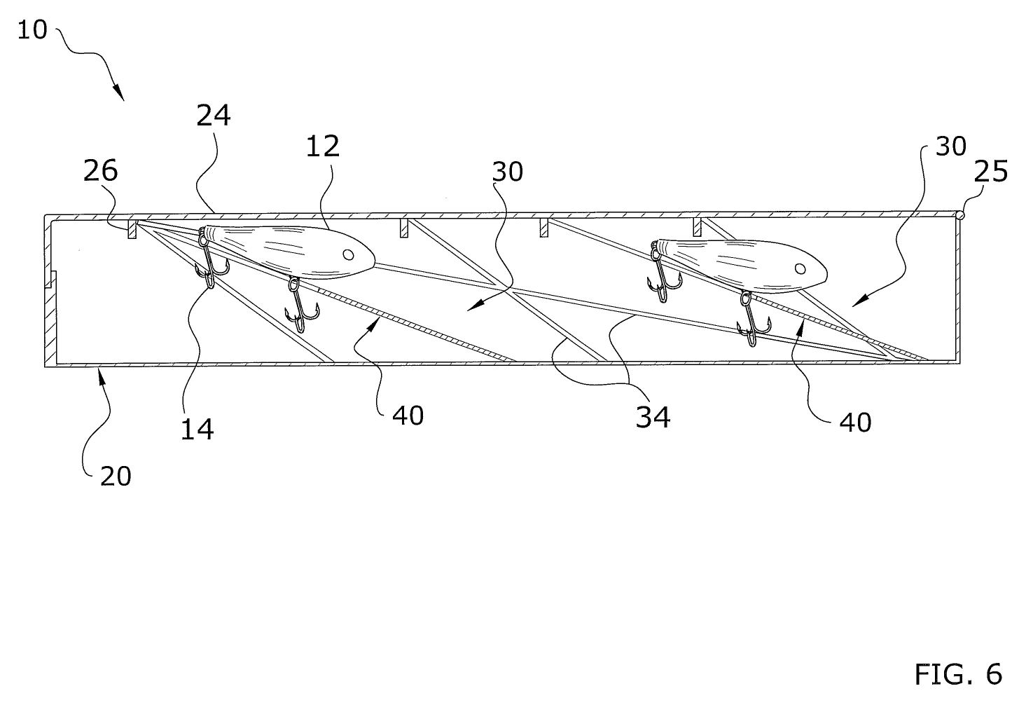

The container 20 also includes a plurality of stopper members 26 extending perpendicularly downward from the lid 24 as illustrated in FIGS. 5 and 6. The stopper members 26 are preferably comprised of elongated members extending across the lid 24 from side to side. When the lid 24 is closed over the opening 27, the stopper members 26 preferably extend over a front of a receiving edge 45 and the slots 47 of the panel 40 as illustrated in FIGS. 5 and 6. The stopper members 26 subsequently prevent the fishing lure 12 from sliding out of the slot 47 and off the panel 40.

It is appreciated that the present invention includes a plurality of stopper members 26 to accommodate the various number and configuration of panels 40 that may be positioned within the container 20 as illustrated in FIGS. 5 and 6. The stopper members 26 also preferably do not extend down a sufficient distance to prevent the currently non-utilized stopper members 26 from interfering with or engaging the fishing lures 12. The stopper members 26 are also preferably fixedly attached to the lid 24; however it is appreciated that the stopper members 26 may be removably attached to the lid 24, wherein the user may attach a respective stopper member 26 if utilizing the corresponding panel 40.

Each of the sidewalls 22 includes a plurality of grooves 32, 34 as illustrated in FIG. 1. The grooves 32, 34 collectively receive the panel 40 when attaching the panel 40 within the container 20. A first sidewall 22 of the pair of sidewalls 22 further includes a plurality of first grooves 32 and a second sidewall 22 of the pair of sidewalls 22 includes a plurality of second groove 34. The first grooves 32 and the second grooves 34 mirror each other, wherein the configuration of the first grooves 32 is preferably identical to the configuration of the second grooves 34.

The grooves 32, 34 extend from the opening 27 of the container 20 to the base 21 of the container 20 upon the sidewalls 22. The grooves 32, 34 may extend at varying angles to efficiently receive various size panels 40. In the preferred embodiment, the length of the grooves 32, 34 are configured to receive either a plurality of small panels 40, a plurality of medium size panels 40 or a large panel 40. Lesser length grooves 32, 34 subsequently extend at a more vertical angle than the longer length grooves 32, 34. The small, medium and large panels 40 are preferably utilized to secure a respective plurality of small, medium or large size fishing lures 12 as illustrated in FIGS. 5 and 6.

The grooves 32, 34 preferably intersect with each other along each sidewall 22 to allow for multiple configurations of grooves 32, 34 to accommodate a small space. The grooves 32, 34 also preferably each extend at an upward angle so as to allow the user to more easily insert and remove the fishing lures 12 from the panel 40. The upper end of the grooves 32, 34 is also preferably positioned above the upper end of the end wall 23 including the second connecting portion 29 so as to prevent the end wall 23 from interfering with the user inserting the various panels 40 and/or fishing lures 12.

The container 20 also includes at least one compartment 30 to position a panel 40 and a respective plurality of fishing lures 12 within. When utilizing multiple panels 40, the container 20 subsequently preferably includes multiple compartments 30 as illustrated in FIGS. 5 and 6. It is appreciated thus that the number of compartments 30 formed corresponds with the number of panels 40 utilized.

It is also appreciated that the container 20 may include various supports to support the center of the panels 40 within the container 20 and prevent the panels 40 from sagging when the panels 40 are utilized to secure a plurality of fishing hooks 14. It is appreciated that the supports may be fixedly attached within the container 20 or removably attached and may be comprised of various configurations.

### C. Panel

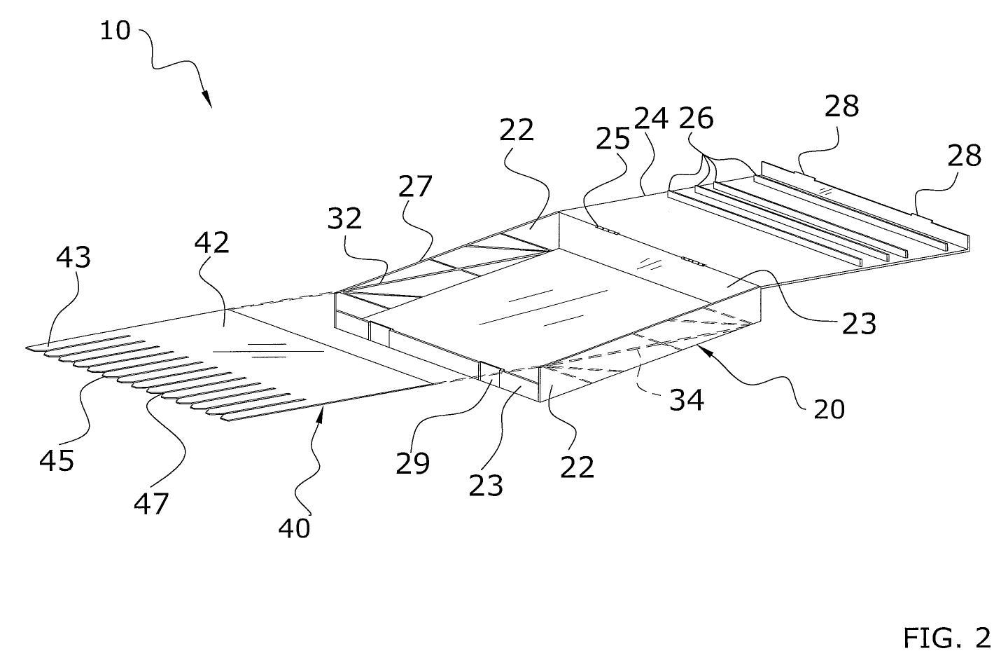

The panel 40 is utilized to secure the fishing lures 12 and is removably positioned within the container 20 as illustrated in FIG. 2. The panel 40 is also preferably comprised of a durable and substantially waterproof material, such as but not limited to plastic, wood or metal. In the preferred embodiment, the panel 40 is comprised of a rectangular shaped structure; however it is appreciated that the panel 40 may be comprised of various shapes and configurations rather than the preferred embodiment all which may be efficiently receives by the plurality of grooves 32, 34. The panel 40 is also preferably comprised of a substantially flat and thin configuration to efficiently slide within the grooves 32, 34 and occupy a minimal amount of space within the container 20.

The panels 40 may be comprised of various sizes to selectively be received within the various length grooves 32, 34 as illustrated in FIGS. 5 and 6. Each of the panels 40 includes an inner end 42 and an outer end 43 as illustrated in FIG. 2. When inserting the panels 40 within the grooves 32, 34 the inner end 42 is inserted first and extends toward the base 21 of the container 20. The outer end 43 is subsequently positioned adjacent the opening 27 of the container 20 and slightly under the upper edge of the sidewalls 22 so as not to interfere with the closing of the lid 24.

The panel 40 also extends at an upward angle with respect to the base 21 and further preferably defines an acute angle with respect to the base 21. The upward angle allows for a user to more easily insert and remove the fishing lures 12 from the panel 40. The angle of the panel 40 is also substantially similar to the angle of the grooves 32, 34.

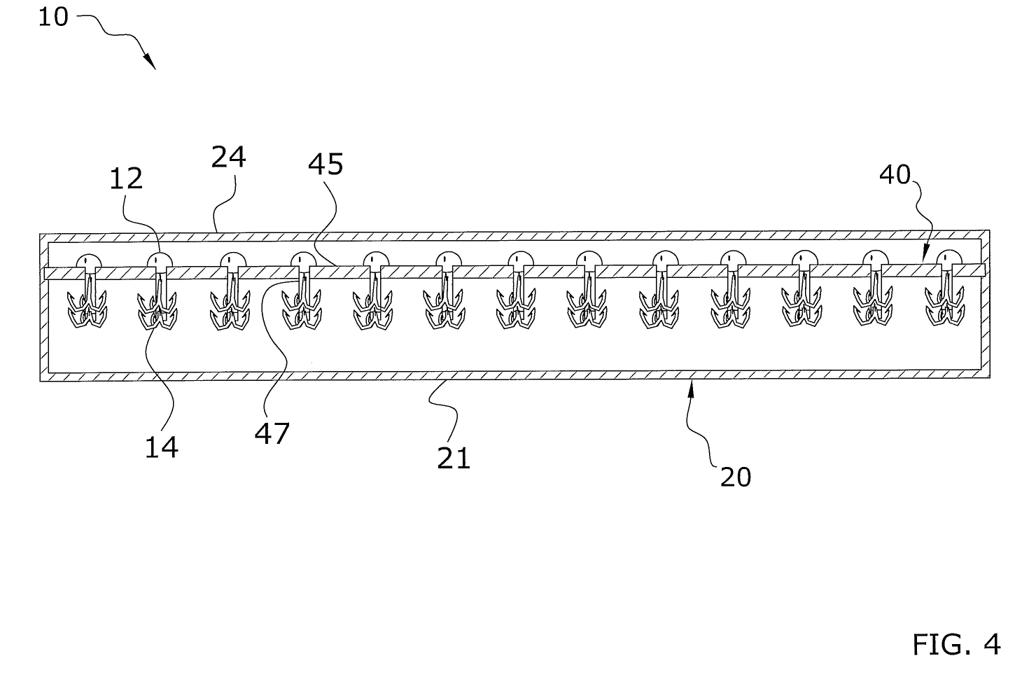

Each panel 40 also includes a plurality of slots 47 extending within the outer end 43 of the panel 40 and toward the inner end 42. The slots 47 are preferably spaced equidistant from each other and are also spaced at a sufficient distance apart so as to be able to position a fishing lure 12 within each slot 47 and not interfere with an adjacent fishing lure 12. The width of the slots 47 is also large enough to receive the portion of the fishing lure 12 between the body of the fishing lure 12 and the tip of the hook 14 of the fishing lure 12 as illustrated in FIGS. 4 and 6.

The receiving edges 45 of the panel 40 (adjacent the outer end 43) are preferably rounded so as to more easily insert the fishing lures 12 within the slots 47. It is appreciated however that the receiving edges 45 may be comprised of various configurations, such as but not limited to angled or straight.

### D. Operation of Preferred Embodiment

In use, the lid 24 of the container 20 is first opened and depending upon what size fishing lures 12 are to be utilized and how many fishing lures 12 are to be utilized a respective panel(s) 40 is slidably inserted within the container 20 as illustrated in FIG. 2. The panel(s) 40 is inserted within a respective set of grooves 32, 34. Once the panel(s) 40 is secured within the grooves 32, 34 the fishing lures 12 may be inserted within each of the desired slots 47 as illustrated in FIGS. 3 and 4.

The lid 24 may now be closed and latched shut via the first connecting portion 28 and the second connecting portion 29. When it is desired to utilize a fishing lure 12 the lid 24 is simply opened and a desired fishing lure 12 may be removed from a respective slot 47. The user may also, at any time, remove a respective panel 40 and insert a different panel 40 of a desired size.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. An adjustable fishing tackle box system, comprising:
a container including a base, a pair of sidewalls, a pair of end walls adjacent said pair of sidewalls and a lid;
wherein said container includes at least one compartment positioned between said pair of sidewalls; and
at least one panel removably positioned within said container, wherein said at least one panel includes a plurality of slots extending within said at least one panel.

2. The adjustable fishing tackle box system of claim 1, wherein said at least one panel is slidably positioned within said container.

3. The adjustable fishing tackle box system of claim 1, wherein said at least one panel and said base define an acute angle.

4. The adjustable fishing tackle box system of claim 1, wherein said at least one panel is positioned within said container at an upward angle with respect to said base.

5. The adjustable fishing tackle box system of claim 1, wherein said pair of sidewalls each include a plurality of grooves to collectively receive said at least one panel.

6. The adjustable fishing tackle box system of claim 5, wherein said plurality of grooves along each of said pair of sidewalls intersect each other.

7. The adjustable fishing tackle box system of claim 5, wherein said plurality of grooves extend from an opening of said container to said base.

8. The adjustable fishing tackle box system of claim 1, wherein a first sidewall of said pair of sidewalls includes a plurality of first grooves and a second sidewall of said pair of sidewalls includes a plurality of second grooves, wherein said plurality of first grooves mirrors said pair of second grooves.

9. The adjustable fishing tackle box system of claim 8, wherein said plurality of first grooves and said plurality of second grooves collectively receive opposing sides of said at least one panel.

10. The adjustable fishing tackle box system of claim 1, wherein said lid includes at least one stopper members extending downwards.

11. The adjustable fishing tackle box system of claim 10, wherein said at least one stopper member extends over a receiving edge of said at least one panel.

12. The adjustable fishing tackle box system of claim 1, wherein said at least one panel includes a plurality of panels removably positioned within said container.

13. The adjustable fishing tackle box system of claim 12, wherein said plurality of panels extend at an upward angle with respect to said base.

14. The adjustable fishing tackle box system of claim 13, wherein said plurality of panels are slidably positioned within a plurality of grooves extending along said pair of sidewalls.

15. An adjustable fishing tackle box system, comprising:
a container including a base, a pair of sidewalls, a pair of end walls adjacent said pair of sidewalls and a lid;
wherein said container includes at least one compartment positioned between said pair of sidewalls;
wherein said pair of sidewalls each include a plurality of grooves extending along said pair of sidewalls; and
at least one panel removably positioned within said container, wherein said at least one panel includes a plurality of slots extending within said at least one panel;
wherein said at least one panel is slidably positioned within said plurality of grooves of said container.

16. The adjustable fishing tackle box system of claim 15, wherein said at least one panel and said base define an acute angle.

17. The adjustable fishing tackle box system of claim 15, wherein said at least one panel is positioned within said container at an upward angle with respect to said base.

18. The adjustable fishing tackle box system of claim 15, wherein said at panel includes a plurality of panels removably positioned within said container.

19. The adjustable fishing tackle box system of claim 18, wherein said plurality of panels are slidably positioned within said plurality of grooves extending along said pair of sidewalls at an upward angle with respect to said base.

20. An adjustable fishing tackle box system, comprising:
a container including a base, a pair of sidewalls, a pair of end walls adjacent said pair of sidewalls and a lid;
wherein said container includes at least one compartment positioned between said pair of sidewalls;
wherein said pair of sidewalls each include a plurality of grooves extending along said pair of sidewalls; and
at least one panel removably positioned within said container, wherein said at least one panel includes a plurality of slots extending within said at least one panel;
wherein said at least one panel is slidably positioned within said plurality of grooves of said container;
wherein said at least one panel and said base define an acute angle and wherein said at least one panel is positioned within said container at an upward angle with respect to said base;
wherein said plurality of grooves to collectively receive said at least one panel and wherein said plurality of grooves along each of said pair of sidewalls intersect each other;
wherein said plurality of grooves extend from an opening of said container to said base;
wherein said lid includes at least one stopper members extending downwards and wherein said at least one stopper member extends over a receiving edge of said at least one panel.
